(19) United States
(12) Patent Application Publication
(10) Pub. No.: US 2001/0022035 A1
(43) Pub. Date: Sep. 20, 2001

(54) Adhesive-coated measuring device

(76) Inventor: Frank Veloce, Orono (CA)

Correspondence Address: MANELLI DENISON & SELTER, 2000 M STREET NW SUITE 700, WASHINGTON, DC, 20036-3307, US

(21) Appl. No.: 09/797,710

(22) Filed: Mar. 5, 2001

(30) Foreign Application Priority Data
Mar. 7, 2000 (CA) 2,300,561

(51) Int. Cl. G01B 3/10; G01B 3/04

(52) U.S. Cl. 33/758; 33/483

(57) ABSTRACT

A measuring device comprising a planar elongate member having a first or upper face and a second or lower face; the first face bearing a plurality of indicia markings thereon denoting longitudinal distances between the markings; and the second face having a layer of a self-adhesive composition. The adhesive coated measuring tape is user-friendly in providing a simple, fast and accurate method of maintaining a precise position on an object.

### FIELD OF THE INVENTION

This invention relates to adhesive-coated measuring devices, particularly, said devices in the form of a roll of flexible tape.

### BACKGROUND OF THE INVENTION

Adhesive-backed rolls of tape, such as marking tape, insulation tape, clear plastic SCOTCH® tape and the like are in common and widespread use for adhesion to an article, such as drywall, wallboard, electrical conduit, packaging and envelopes to seal joints, insulate wires and wrapping and sealing, respectively. Similarly, measuring devices such as rulers and measuring tapes, retractable into a casing or otherwise are also well-known in widespread personal and commercial use for determining the dimensions of an object, measurement of a distance and the like. Unfortunately, the taking of measurements with such rulers or tape measures often involves the taking of measurement of a dimension of an object immediately followed up by mark-up with chalk, pencil, crayon, scoring or the like; and subsequently carrying out the function on the object, e.g. sawing, cutting, sewing or the like. Unfortunately, locating on and subsequent removal of the measuring tape/ruler from the object often produces dimensional measurement errors which result in inexact dimensional products. Further, such actions can be time-consuming, and awkward as to be non-user-friendly.

There is, therefore, a need to provide a fast, user-friendly, cheap means for marking up the precise position on an object for subsequent action.

### SUMMARY OF THE INVENTION

It is an object of the present invention to provide a measuring device which is accurate, simple, fast and user-friendly as to enable the precise position on an object to be identified.

Accordingly, in one aspect the invention provides a measuring device comprising a planar elongate member having a first or upper face and a second or lower face; said first face bearing a plurality of indicia markings thereon denoting longitudinal distances between said markings; and said second face having a layer of a self-adhesive composition.

The adhesive-coated measuring device according to the invention may be formed of a rigid material, such as a metal, e.g. aluminum, or non-metal, such as wood or a rigid plastics material.

Most preferably, the device is constituted as a roll, cylinder and the like of a tape formed of a fabric or, more preferably, a clear plastics material such as, for example, SCOTCH® tape, having a coating or layer of a self-adhesive composition.

The markings on the tape may be, preferably, the standard lengthwise markings of imperial—feet and inches, and/or metric—meters and centimeters; and the like in common prior art rulers and tape measures.

### BRIEF DESCRIPTION OF THE DRAWINGS

In order that the invention may be better understood, preferred embodiments will now be described by way of example only, with reference to the accompanying drawings wherein

FIG. 1 is a diagrammatic, perspective view of an adhesive-coated measuring tape according to the invention; and

FIG. 2 is a diagrammatic, perspective view of an adhesive-coated ruler according to the invention.

### DETAILED DESCRIPTION OF PREFERRED EMBODIMENTS

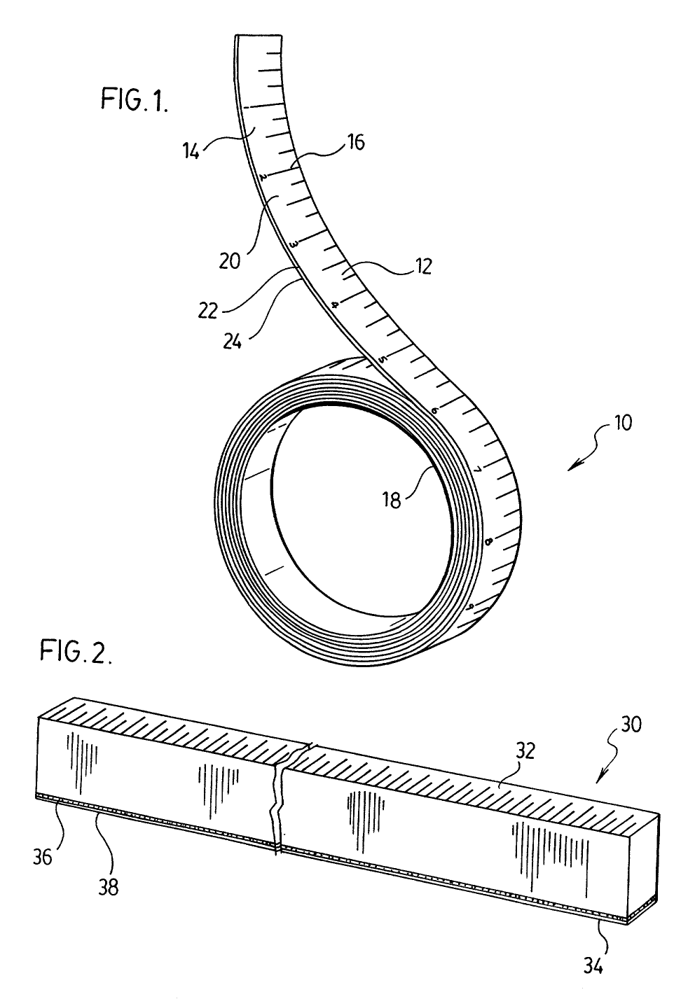

FIG. 1 shows generally as 10, a roll of an adhesive-coated measuring tape according to the invention, constituted as a clear-plastics, planar elongate tape 12 rolled up to a length of about 25 meters with a terminal length portion 14 and bearing distance markings 16 (inches in the embodiment shown) on a first or upper face 20. Tape 12 has a lower or second face 22 bearing an adhesive coating layer 24, which in the tape-rolled up position abuts face 20 in air-tight, releasable arrangement. Tape 12 is operably pulled-off its core tube 18 to provide its adhesive-coated layer as a “sticky” surface to effect adhesion to an object (not shown) upon which subsequent action may be performed, such as sawing, cutting, sewing, without removal therefrom for accurate location of the desired measured location.

The preferred embodiment of the invention is most, optionally, disposable. The distance markings may be repeated along the length of the tape at any desired length in units, for example, of 1 m, 2 m, 3 m, 4 m, 5 m and the like.

With reference to FIG. 2, this shows generally as 30 a rigid thermoplastics ruler having an upper face 32 and a lower face 34 coated with an adhesive coating 36, itself having a paper air-protective layer 38.

Although this disclosure has described and illustrated certain preferred embodiments of the invention, it is to be understood that the invention is not restricted to those particular embodiments. Rather, the invention includes all embodiments which are functional or mechanical equivalence of the specific embodiments and features that have been described and illustrated.

1. A measuring device comprising a planar elongate member having a first or upper face and a second or lower face; said first face bearing a plurality of indicia markings thereon denoting longitudinal distances between said markings; and said second face having a layer of a self-adhesive composition.

2. A measuring device as defined in claim 1 wherein said member is formed of a flexible material.

3. A measuring device as defined in claim 1 in the form of a roll wherein said upper face contacts said adhesive layer in air-tight, removable abutment.

4. A measuring device as defined in claim 2 wherein said flexible material is formed of a fabric material or a plastics material.

5. A measuring device as defined in claim 1 wherein said member is formed of a rigid material.

6. A measuring device as defined in claim 5 wherein said material is formed of a metal or rigid plastics material.

7. A measuring device as defined in claim 1 wherein said indicia markings are numerals denoting units of length in imperial or metric measurements.

8. A roll of self-adhesive-coated tape bearing measurement markings denoting units of length.

9. A self-adhesive coated roll of tape as defined in claim 8 constituting masking, electrical or clear plastic adhesive coated tape.
